(19) United States
(12) Patent Application Publication
(10) Pub. No.: US 2018/0117955 A1
(43) Pub. Date: May 3, 2018

(54) DECORATIVE MULTI-LAYER COATING FOR HORIZONTAL AND VERTICAL SURFACES

(71) Applicant: EURO TRADE FLOORING, S.L., SANT ESTEVE SES ROVIRES (ES)

(72) Inventors: David GRANADOS PELAEZ, VILADECANS (ES); Luis FERNANDEZ LOPEZ, BARCELONA (ES)

(73) Assignee: EURO TRADE FLOORING, S.L., SANT ESTEVE SES ROVIRES (ES)

(21) Appl. No.: 15/325,747

(22) PCT Filed: Jun. 5, 2015
(86) PCT No.: PCT/EP2015/062536

§ 371 Date: Jan. 12, 2017

(51) Int. Cl. B44C 3/02; B44C 1/10; C09J 7/29

(52) U.S. Cl. CPC B44C 3/02; B44C 1/105; C09J 7/29; C09J 2475/006; C09J 2400/243; C09J 2425/006; C09J 2431/00; C09J 2201/20

(57) ABSTRACT

A decorative multi-layer covering for horizontal and vertical surfaces such as floors and walls, having a decorative layer provided with decorative motifs visible from the outside, a support layer and a self-adhesive layer to be placed on the surface to be covered. The self-adhesive layer has a perforated foam material layer with an outer surface provided with an adhesive. The perforated surface of the foam material layer has between 5% and 95%, and more preferably between 15% and 50%, of the entire surface of one of the two faces of the support layer, which is distributed over several perforations. A stabilising layer can be arranged between the support layer and the self-adhesive foam material layer, the perforations connecting to the lower face of the stabilising layer.

### APPLICATION FIELD OF THE INVENTION

The present invention relates to a decorative multi-layer coating for horizontal and vertical surfaces, such as floors and walls. The multi-layer coating comprises a decorative layer provided with decorative motifs visible from the outside, a support layer and a self-adhesive layer designed to be placed on the surface to be covered.

### BACKGROUND OF THE INVENTION

Vinyl flooring or floors, the composition of which is particularly based on polyvinyl chloride (PVC), is currently very well-known as a substitute for linoleum coatings, due to the fact it is waterproof, resistant to abrasion and chemical agents, anti-slip and easy to clean. Therefore, this type of coating is highly suited to areas that are used and cleaned frequently, such as floors in kitchens, bathrooms or playrooms for children.

The vinyl coatings described tend to be provided with a decorative layer that imitates anything from typical coatings with a wood, granite or ceramic appearance to others with more avant-garde designs that can be obtained by printing any design with a variety of drawings, patterns and colours.

These vinyl coatings are found on the market in two main formats; in the form of tiles or sheets, and as continuous rolls. Coatings in the form of tiles are harder and more rigid than the latter and if a piece is damaged, the floor tile in question need only by substituted, rather than the whole rolled sheet.

With respect to placement, the vinyl coatings in the form of tiles require dispersion glue or adhesive to be applied onto the surface in contact with the floor, although for quite some time now, commercial floor tiles have had a self-adhesive layer, which is protected by a removable sheet of paper, so that it may be applied directly to the floor surface to be covered.

Convenience when applying self-adhesive vinyl coatings on floor surfaces has often lead users to attempt to apply said floor tiles to vertical surfaces, such as walls, although without the expected results since the floor tiles peel off after a short period of time.

There have also been attempts to improve the adhesive power of the self-adhesive layer with new chemical compositions, which considerably increases the manufacturing cost of the tile.

Furthermore, the self-adhesive vinyl coatings designed for covering floors are not suitable for wall surfaces, since the latter are often irregular with ceramic tile joints, unevenness between plasterboards and various imperfections that the vinyl coating reproduces when said irregularities are marked on the board, thus producing a poor aesthetic result.

Therefore, having a suitable coating for both horizontal and vertical surfaces, which is easy to place and which any user may use, is desirable.

### DESCRIPTION OF THE INVENTION

With the aim of providing a solution to the drawbacks set forth, a decorative multi-layer coating for horizontal and vertical surfaces, such as floors and walls, is presented. The multi-layer coating, object of the invention, is of the type comprising a decorative layer provided with decorative motifs visible from the outside, a support layer and a self-adhesive layer designed to be placed on the surface to be covered.

Essentially, the decorative multi-layer coating is characterised in that the self-adhesive layer comprises a layer of perforated foam material with an outer surface provided with an adhesive. The perforations provided in the foam material layer enable the user or operator that must apply the coating on the wall to fill said perforations with silicone, glue or similar material that reinforces the adhesive strength of the coating to the wall surface, the action of the adhesive itself adding to the strength already provided on the outer surface of the foam material layer. Moreover, the perforations in and of themselves are an indication for the user or operator as to where the silicone or similar product must be applied, which means that no mistakes are made when doing this task.

According to a feature of the decorative multi-layer coating of the invention, the perforation surface of the foam material layer comprises between 5% and 95% of the entire surface of one of the two faces of the support layer, which is distributed over several perforations. The perforation surface of the foam material layer preferably represents between 15% and 50% of the entire surface of one of the two faces of the support layer. The perforations may be circular, triangular, rectangular, square, and so on.

In accordance with another feature of the decorative multi-layer coating of the invention, the foam material layer is a layer of polymeric material selected from the group formed of IXPE cross-linked polyethylene foam, XPE cross-linked polyethylene foam, EVA ethylene-vinyl acetate foam, expanded polyurethane foam and polystyrene foam.

In accordance with another feature of the decorative multi-layer coating of the invention, the foam material layer has a thickness comprised between 1 and 50 mm. The thickness of the foam material contributes to making the irregularities that the outer surface of the wall or floor may have uniform, without them being visible from the outside once the coating has be placed. Thus, if for example the outer surface of the wall has a certain relief that is the result of an old finish that the user wishes to cover by applying the coating, object of the invention, the foam material layer deforms in those area where it is applied over a projection or relief on the wall, thus being permanently compressed in said areas in order to be at the same level as the rest of the foam material layer that is devoid of said irregularities. Moreover, if the previous finish of the wall surface to be coated is ceramic tile, the foam material will fill all the joint spaces, which are lower than the ceramic tile pieces, in order to level it.

According to another feature of the decorative multi-layer coating of the invention, a stabilising layer is arranged between the support layer and the self-adhesive layer of foam material. This stabilising layer acts structurally as an expansion compensator and prevents the coating from becoming excessively curved, in both a concave and convex shape, thus helping to keep it flat. This stabilising layer may preferably be polyvinyl chloride (PVC), fibreglass, aluminium, a melamine resin or a combination thereof.

In accordance with another characteristic of the decorative multi-layer coating of the invention, the perforations of the foam material layer connect to the lower face of the stabilising layer. In this way, when the user or operator places the coating on the wall surface, filling the perforations with silicone or a similar product, it ensures that the strength of the adhesive action, which is reinforced by the silicone, is transmitted to the structural portion of the coating, made up of the stabilising layer joined to the support layer.

In accordance with another feature of the decorative multi-layer coating of the invention, each perforation has a circular or polygonal base comprised between 0.7 cm² and 20 cm². In fact, it has been proven that it is more advantageous to distribute the perforated surface of the foam material layer in a greater number of small perforations than to distribute it in a smaller number of large perforations.

According to another feature of the decorative multi-layer coating of the invention, the decorative layer is a layer made of plant, mineral, organic, inorganic, natural or synthetic material, or a mixture thereof. For example, the decorative layer may be formed of a patterned fabric, a wooden sheet with its natural grain or an engraved wooden sheet, a PVC sheet, and so on.

The adhesive of the self-adhesive layer preferably comprises ethyl acetate or an ethylene-vinyl acetate copolymer.

In accordance with another feature of the decorative multi-layer coating of the invention, the adhesive of the self-adhesive layer is covered on the outside by a removable sheet of paper. This removable sheet of paper is removed by the user of the coating just before applying the coating onto the floor or wall surface, thus preventing the coating from adhering to other surfaces and adopting incorrect positions before being placed.

The decorative multi-layer coating, object of the invention, may optionally comprise an outer protective layer arranged over the decorative layer, in order to protect it from wear or outside elements. This outer protective layer may be a polyurethane layer for example.

The support layer of the decorative multi-layer coating, object of the invention, is preferably a layer of vinyl material.

According to another feature of the decorative multi-layer coating of the invention, the coating is square or rectangular shaped, such as a tile (30.5 cm×61 cm) or any other piece that is aesthetically pleasing for coating walls, for example, 17.5 cm×121 cm, 14.5 cm×91 cm, and so on.

### BRIEF DESCRIPTION OF THE DRAWINGS

The attached drawings show, by way of a non-limiting example, one embodiment of the decorative multi-layer coating, object of the invention. In said drawings:

FIG. 1 is a cross-section view of the decorative multi-layer coating, object of the invention;

FIG. 2 is a perspective view of the foam material of the decorative multi-layer coating in FIG. 1; and

FIG. 3 is a cross-section view of the decorative multi-layer coating, object of the invention, once it is placed on a wall surface.

### DETAILED DESCRIPTION OF THE DRAWINGS

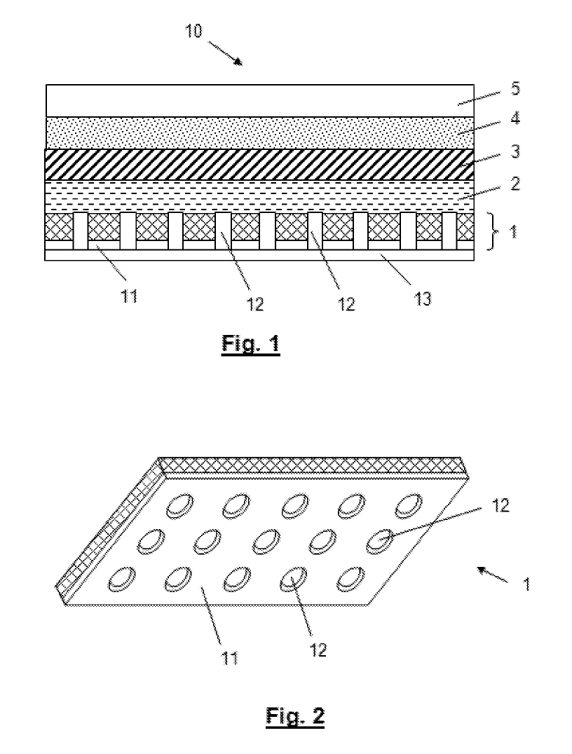

FIG. 1 shows a cross-section of a decorative multi-layer coating 10 in the shape of a tile, suitable for coating horizontal and vertical surfaces such as floors and walls.

The coating 10 represented is formed of the following layers arranged in order one after the other: an outer protective layer 5 (optional), a decorative layer 4, a support layer 3, a stabilising layer 2 and a foam material layer 1, this last layer being a self-adhesive layer and designed to be applied on the horizontal or vertical surface to be covered.

By way of example, some of the possible materials that may make up the aforementioned layers are described below.

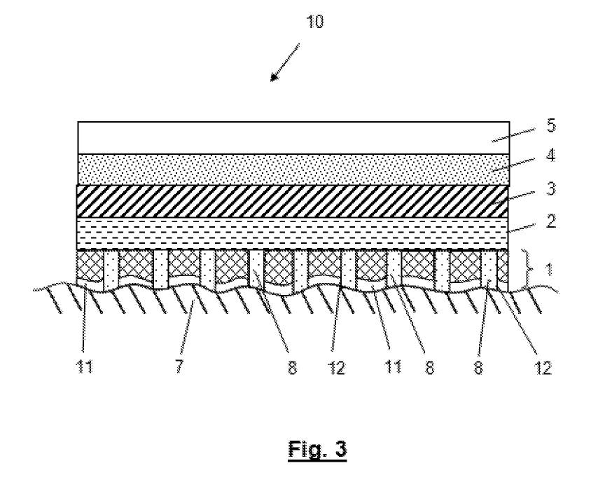

The foam material layer 1 is a layer of polymeric material selected from the group formed of IXPE cross-linked polyethylene foam, XPE cross-linked polyethylene foam, EVA ethylene-vinyl acetate foam, expanded polyurethane foam and polystyrene foam. The foam material layer 1 is a deformable layer that absorbs the irregularities that the wall surface 7 may have, thus preventing said irregularities from affecting the rest of the layers of the coating 10, as seen in FIG. 3. In addition to its function levelling the wall or floor surface, the foam material layer 1 has sound and thermal insulation properties.

The stabilising layer 2 acts structurally as an expansion compensator and prevents the tile-shaped coating 10 from becoming excessively curved, in both a concave and convex shape, in adverse environmental conditions, thus helping to keep it flat. This stabilising layer 2 may be polyvinyl chloride (PVC) or fibreglass.

With regard to the support layer 3, it may be a vinyl material, for example.

The decorative layer 4 may be made of a plant, mineral, organic, inorganic, natural or synthetic material, or a mixture thereof. For example, the decorative layer 4 may be formed of a patterned fabric, a wooden sheet with its natural grain or an engraved wooden sheet, a PVC sheet, a metal sheet and so on.

Depending on the type of decorative layer 4, the coating 10 may comprise an outer protective layer 5 arranged over the decorative layer 4, in order to protect it from wear or outside elements. As well as being resistant, the outer protective layer 5 must be a material that enables the decorative layer 4 it covers to be seen correctly. For example, the material of said outer protective layer 5 may be highly resistant and transparent polyurethane.

The foam material layer 1 is provided with an adhesive 11 on the face opposite the stabilising layer 2, which makes the foam material layer 1 self-adhesive, along with the tile that makes up the coating 10. The adhesive 11 of the self-adhesive layer comprises ethyl acetate or an ethylene-vinyl acetate copolymer.

In addition to the layers described above, FIG. 1 shows that the adhesive 11 spread over the outer face of the foam material layer is covered on the outside by a removable sheet of paper 13 that the user removes when applying the coating 10 on the wall 7 or ground.

A particular feature of the foam material layer 1 is that it is a perforated layer, being provided with several distributed perforations 12 that pass through the layer, as shown in FIG. 2. The perforation surface of the foam material layer 1 comprises between 5% and 95% of the entire surface of one of the two faces of the support layer 3 or the stabilising layer 2, since all the layers of the coating 10, except the foam material layer 1, have faces with the same surface. The perforated surface of the foam material layer 1 preferably comprises between 15% and 50% of the entire surface of one of the two faces of the support layer 3. Generally, each perforation 12 has a circular or polygonal base and comprises between 0.7 cm² and 20 cm², depending on the size of the coating tile 10 and its total weight.

The perforations 12 provided in the foam material layer 1 enable the user or operator that must apply the coating 10 on the wall 7 to fill said perforations 12 with an adhesive filling material 8, such as adhesive silicone, glue or a similar product that reinforces the adhesive strength of the coating 10 to the wall surface 7, the action of the adhesive 11 itself adding to the strength already provided by the outer surface of the foam material layer 1. There are different products on the market that may be used as an adhesive filling material 8, for example a fast-grabbing elastic adhesive, the composition of which is formed of calcium carbonate, ethyltrimethoxysilane, 3-trimethoxysilyl-1-propanamine and titanium dioxide, with a density of between 1.54 and 1.58 g/cm³ (at 23° C.) with a thick consistency.

The number, arrangement and size of the perforations 12 are calculated so that the amount of silicone or glue with which they are filled, along with the adhesive action of the adhesive 11, is appropriate for the tile-shaped coating 10 to be permanently placed on the wall surface 7 with it peeling off or moving. Thus, the perforations 12 act as a guide for the user to know where and how much silicone to apply in order to correctly secure the coating 10, which means that no mistakes are made when mounting or applying the coating 10. Generally, the perforations 12 and the arrangement thereof have been designed taking into account the normal resistance and adhesion values of the majority of glues, silicones and similar products found on the market. However, in order to make the application of the tile-shaped or rectangular coating 10 on the wall 7 even easier, it has been provided that the tiles or pieces of coating 10 be marketed along with the adhesive filling product.

By way of example, a 30.5 cm×61 cm coating tile, weighing approximately 700 g, has a total of 72 perforations with a diameter of 2 cm, which are uniformly distributed in twelve rows and six columns, on the foam material layer. It has been proven that applying the fast-grabbing elastic adhesive (described two paragraphs above) in just 50% of the perforations offers a high level of stability and resistance against the tile peeling off, a minimum force of 0.2 N/mm² being necessary to separate the tile from the wall 7, thus calculating that the tile will remain adhered to the wall surface 7 for at least eight years.

1. A decorative multi-layer coating for horizontal and vertical surfaces such as floors and walls, comprising a decorative layer provided with decorative motifs visible from the outside, a support layer and a self-adhesive layer designed to be placed on the surface to be covered, characterised in that the self-adhesive layer comprises a perforated foam material layer with an outer surface provided with an adhesive.

2. The decorative multi-layer coating, according to claim 1, wherein the perforated surface of the foam material layer comprises between 5% and 95% of the entire surface of one of the two faces of the support layer, which is distributed over several perforations.

3. The decorative multi-layer coating, according to claim 2, wherein the perforated surface of the foam material layer comprises between 15% and 50% of the entire surface of one of the two faces of the support layer.

4. The decorative multi-layer coating, according to claim 1, wherein the foam material layer, provided with several perforations, is a layer of polymeric material selected from the group formed of IXPE cross-linked polyethylene foam, XPE cross-linked polyethylene foam, EVA ethylene-vinyl acetate foam, expanded polyurethane foam and polystyrene foam.

5. The decorative multi-layer coating, according to claim 1, wherein the foam material layer, provided with several perforations, has a thickness comprised between 1 and 50 cm.

6. The decorative multi-layer coating, according to claim 1, wherein a stabilising layer is arranged between the support layer and the self-adhesive foam material layer.

7. The decorative multi-layer coating, according to claim 6, wherein the stabilising layer is a layer made of polyvinyl chloride, fibreglass, aluminium, melamine resin or a combination thereof.

8. The decorative multi-layer coating, according to claim 6, wherein the perforations of the foam material layer connect to the lower face of the stabilising layer.

9. The decorative multi-layer coating, according to claim 8, wherein each perforation has a circular or polygonal base comprised between 0.7 cm² and 20 cm².

10. The decorative multi-layer coating, according to claim 1, wherein the decorative layer is a layer made of plant, mineral, organic, inorganic, natural or synthetic material, or a mixture thereof.

11. The decorative multi-layer coating, according to claim 1, wherein the adhesive of the self-adhesive layer comprises ethyl acetate or an ethylene-vinyl acetate copolymer.

12. The decorative multi-layer coating, according to claim 1, wherein the adhesive of the self-adhesive layer is covered by a removable sheet of paper.

13. The decorative multi-layer coating, according to claim 1, comprising an outer protective layer arranged over the decorative layer.

14. The decorative multi-layer coating, according to claim 13, wherein the outer protective layer is a polyurethane layer.

15. The decorative multi-layer coating, according to claim 1, wherein the support layer is a vinyl material layer.

16. The decorative multi-layer coating, according to claim 1, wherein the coating has a square or rectangular piece format.
